(19) United States
(12) Patent Application Publication
(10) Pub. No.: US 2009/0178525 A1
(43) Pub. Date: Jul. 16, 2009

(54) CUTTING SPEED DISPLAY DEVICE

(75) Inventors: Long-Chang JAN, Changhua County (TW); Hsuan-Chu Liu, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: OAV Equipment & Tools, Inc., Taichung Hsien (TW)

(21) Appl. No.: 12/127,410

(22) Filed: May 27, 2008

(30) Foreign Application Priority Data
Jan. 15, 2008 (TW) 97200953

(51) Int. Cl. B23Q 15/08; B23D 55/00

(52) U.S. Cl. 83/72; 83/788

(57) ABSTRACT

Installed in a band saw formed of a frequency converter, a motor, a driving wheel set and a band saw blade, a cutting speed display device is disclosed to include a modulator electrically connected to the frequency converter to output a linear modulation signal to the frequency converter for modulating the frequency of the output electrical power of the frequency converter so as to regulate the speed of the motor, and a display device that has a circuit device electrically connected to the modulator for receiving the linear modulation signal outputted by the modulator and converting the received linear modulation signal into a band saw blade cutting speed subject to one of a number of calculation modules set therein for enabling the band saw blade cutting speed to be displayed on the display panel. Thus, the cutting speed display device indicates the cutting speed of the band saw blade of the band saw in real time, and eliminates the problem of floating of the displayed data.

### BACKGROUND OF THE INVENTION

1. Field of the Invention

The present invention relates to band saws and more particularly, to a cutting speed display device for a band saw.

2. Description of the Related Art

When a user is operating a band saw, the user can adjust the cutting speed of the band saw subject to the type of the workpiece to be cut, for example, adjusting the cutting speed of the band saw to a high speed mode when cutting a wooden workpiece, or to a low speed mode when cutting a metal workpiece. Adjusting the cutting speed subject to the type of the workpiece to be cut prevents damage to the band saw blade and enables the band saw to achieve high performance. Therefore, band saws with cutting speed display means are developed.

Regular band saws with cutting speed display means include two types as follows:

1. The frequency converter that is used to control the speed of the motor and to further control the speed of the band saw blade directly indicates the power frequency or RPM (revolutions per minute) of the motor, enabling the operator to judge the operating speed of the band saw.

2. A sensor is installed in the band saw to detect the movement of the band saw blade and to indicate the linear speed of the band saw blade directly.

However, the aforesaid two types of cutting speed display designs are still not satisfactory in function. When a cutting speed display device is used to indicate the power frequency or RPM (revolutions per minute) of the motor subject to the operation status of the frequency converter, the displayed data is not the linear speed of the band saw blade, and therefore the operator cannot know the actual linear speed of the band saw blade at the first time, and the operator may encounter a reading error. Further, when a sensor is used to detect the movement of the band saw blade and to indicate the linear speed of the band saw blade directly, the reaction time of the detection of the sensor is subject to the length of the band saw blade. When adjusting the speed, the cutting speed display device can display the set cutting speed only after the band saw has run through one turn, i.e., the operator cannot know the linear speed of the band saw blade immediately after adjustment. Further, when the band saw blade is bearing the load during a cutting operation, the display data is floating, causing the operator difficulty in reading the display data.

Therefore, it is desirable to provide a cutting speed display device that eliminates the aforesaid problems.

### SUMMARY OF THE INVENTION

The present invention has been accomplished under the circumstances in view. It is the main object of the present invention to provide a cutting speed display device, which is practical for use in a band saw to indicate the cutting speed of the band saw blade in real time without causing floating of displayed data. It is another object of the present invention to provide a cutting speed display device, which indicates the band saw blade cutting speed subject to the type of the workpiece to be cut, facilitating an operator's manipulation of the band saw.

To achieve these and other objects of the present invention, the cutting speed display device is installed in a band saw. The band saw comprises a frequency converter, a motor, a driving wheel set and a band saw blade. The frequency converter is adapted for regulating the speed of the motor. The motor is adapted for rotating the driving wheel set to move the band saw blade. The driving wheel set is comprised of a plurality of driving wheels that have different diameters and are selectively coupled to the motor for driving the band saw blade. The cutting speed display device comprises a modulator electrically connected to the frequency converter, and a display device. The modulator is adapted for outputting a linear modulation signal to the frequency converter to modulate the frequency of the output electrical power of the frequency converter and to further regulate the speed of the motor. The display device comprises a circuit device electrically connected to the modulator, and a display panel electrically connected to the circuit device. The circuit device is adapted for receiving the linear modulation signal outputted by the modulator and converting the received linear modulation signal into a band saw blade cutting speed for display on the display panel subject to one of a number of calculation modules set therein. Therefore, when the cutting speed display device of the present invention is used in a band saw, it indicates the cutting speed of the band saw blade of the band saw in real time and eliminates the problem of floating of the displayed data.

### BRIEF DESCRIPTION OF THE DRAWING

FIG. 1 is a perspective view showing a cutting speed display device installed in a band saw according to a first embodiment of the present invention.

FIG. 2 is a schematic drawing, showing the module of the first embodiment of the present invention.

FIG. 3 is a display flow chart of the first embodiment of the present invention.

FIG. 4 is a perspective view of a part of a band saw according to a second embodiment of the present invention.

### DETAILED DESCRIPTION OF THE INVENTION

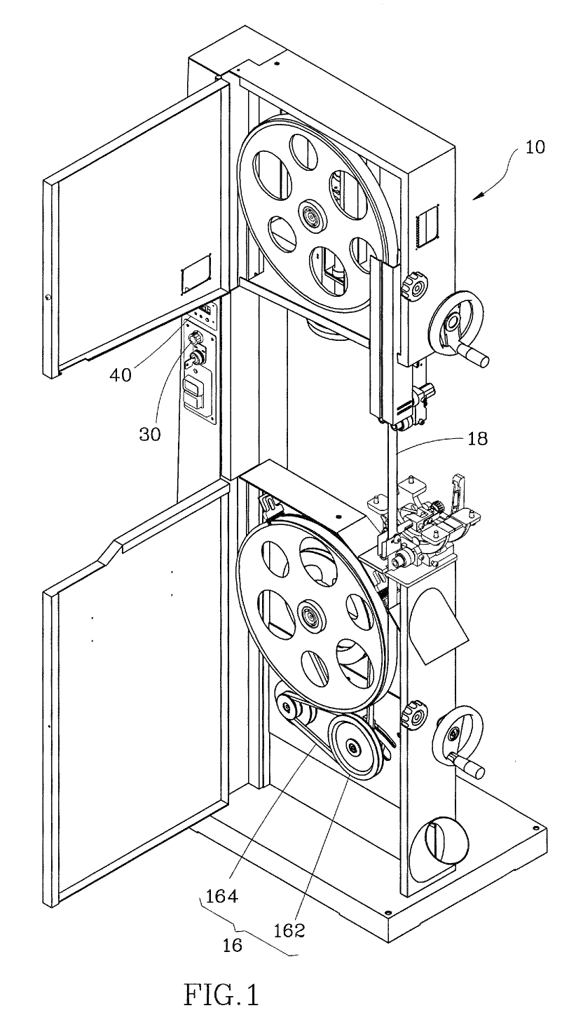

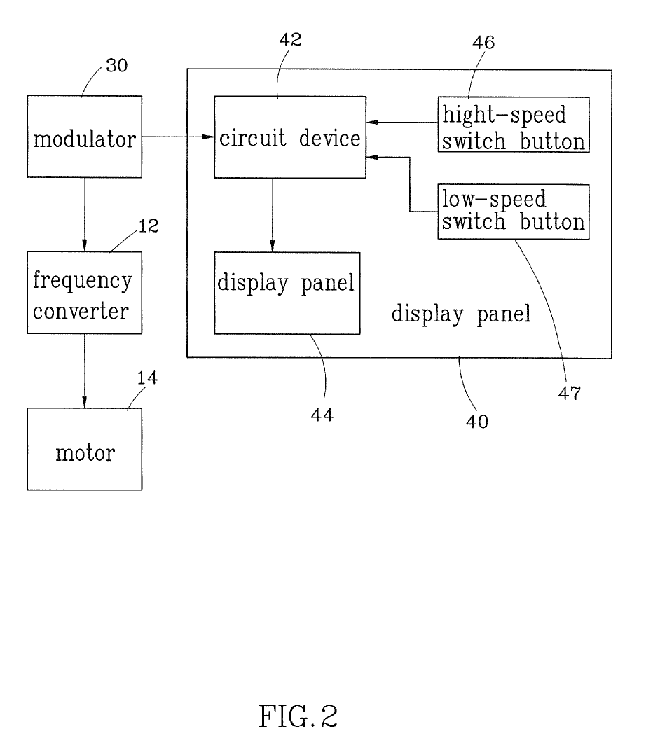

Referring to FIGS. 1 and 2, a cutting speed display device is installed in a band saw 10. The band saw 10 comprises a frequency converter 12, a motor 14, a driving wheel set 16 and a band saw blade 18. The frequency converter 12 receives external power source and outputs an electrical power to the motor 14. Further, the frequency converter 12 can be set to output an electrical power subject to the desired frequency, regulating the speed of the motor 14. The driving wheel set 16 is coupled to the motor 14, and comprised of a plurality of wheels 162 of different diameters and a transmission belt 164. The driving wheel set 16 is driven by the motor 14 to move the band saw blade 18. The cutting speed display device in accordance with the first embodiment of the present invention includes a modulator 30 and a display device 40.

The modulator 30 is electrically connected to the frequency converter 12. According to this embodiment, the modulator 30 is a variable resistor. The modulator 30 outputs a linear modulation signal to the frequency converter 12, causing the frequency converter 12 to modulate the frequency of its electrical power output and to further regulate the speed of the motor 14.

The display device 40 comprises a circuit device 42, a display panel 44, a high-speed switch button 46 and a low-speed switch button 47. The circuit device 42 is electrically connected to the modulator 30, having built therein a high-speed ratio calculation module and a low-speed ratio calculation module that can be set by the high-speed switch button 46 and the low-speed switch button 47 respectively. The display panel 44 is electrically connected to the circuit device 42, and adapted for receiving the calculated speed from the circuit device 42.

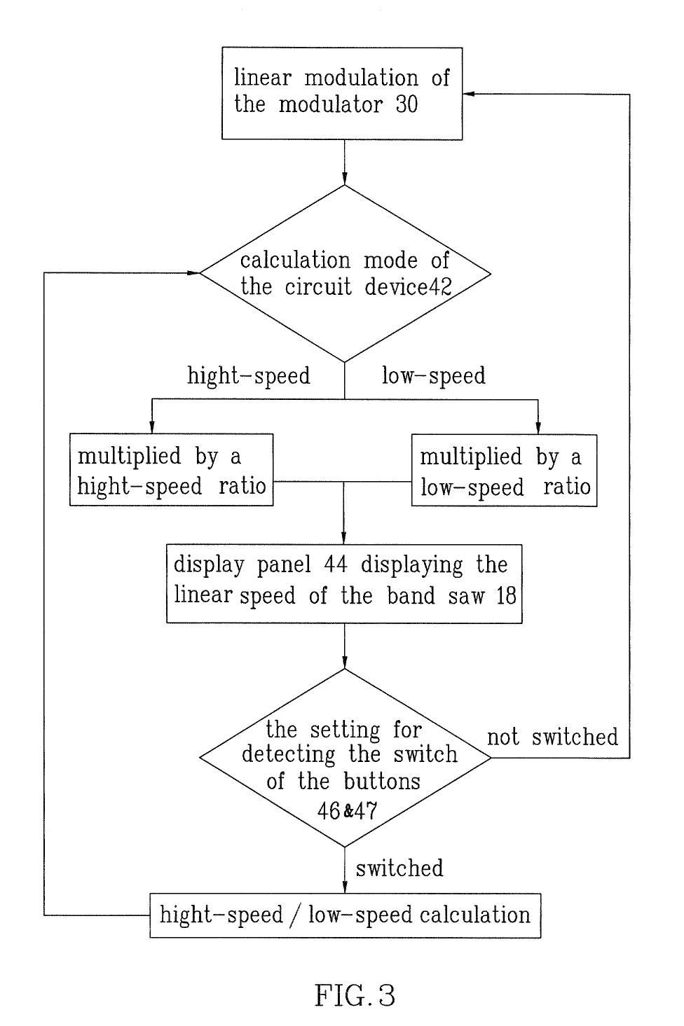

Referring to FIG. 3, the operation of the present invention is outlined hereinafter. When the modulator 30 is outputting a linear modulation signal to the frequency converter 12 to regulate the speed of the motor 14, the circuit device 42 of the display device 40 simultaneously receives the linear modulation signal. Subject to the high-speed ratio calculation module or low-speed ratio calculation module set by the high-speed switch button 46 or the low-speed switch button 47, the circuit device 42 performs a high-speed or low-speed ratio conversion calculation and then outputs the converted linear speed data to the display panel 44 for display. When the high-speed switch button 46 or the low-speed switch button 47 is switched to change the high speed mode or low speed mode, the related linear speed is immediately displayed on the display panel 44.

Therefore, when the invention is used in the aforesaid band saw 10 to indicate the linear speed of the band saw blade 18, the user can switch on the high-speed switch button 46 when cutting a wooden workpiece, enabling the display panel 44 to display the accurate linear speed of the band saw blade 18. When cutting a metal workpiece, the user can switch on the low-speed switch button 47, enabling the display panel 44 to display the accurate linear speed of the band saw blade 18. Because the modulator 30 is operating independently, the signal being received by the circuit device 42 is free from the effect of the load, eliminating the problem of floating of the displayed speed value.

Preferably, the modulator 30 can be formed of two variable resistors that are linked together. One variable resistor outputs a linear modulation signal to the frequency converter 12 independently. The other variable resistor outputs a linear modulation signal to the display device 40. Therefore, the linear modulation signal received by the frequency converter 12 and the linear modulation signal received by the display device 40 do not interfere with each other, assuring high accuracy of the linear speed displayed on the display device 40.

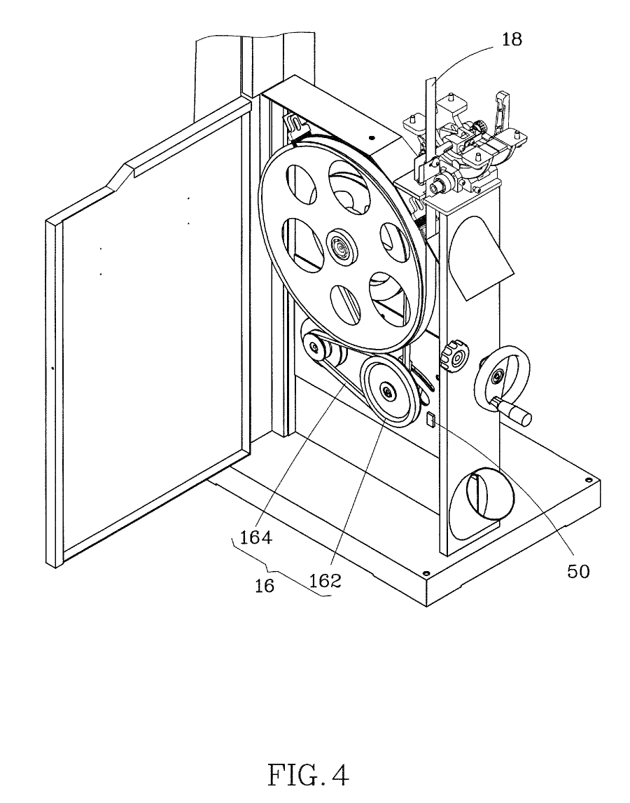

FIG. 4 illustrates a cutting speed display device in accordance with a second embodiment of the present invention. This second embodiment is substantially similar to the aforesaid first embodiment with the exception of an additional sensor 50. The sensor 50 is installed in the driving wheel set 16, and electrically connected to the display device 40. When the user shifted the transmission from one wheel 162 of the driving wheel set 16 to another, the sensor 50 detects the diameter ratio of the wheel 162 in operation, and switches the calculation module of the circuit device 42 subject to the detection result, so that the display device 40 displays the linear speed of the band saw blade 18 accurately, avoiding band saw damage due to improper operation.

As stated above, the invention has the following features: by means of the linear modulation signal from the modulator 30 to regulate the speed of the motor 14 and to have the cutting speed of the band saw blade 18 be displayed on the display device 40, the invention indicates the cutting speed in real time and eliminates the problem of floating of displayed data; the linear speed display is relatively changed subject to subject to change of the type of workpiece so that the operator can conveniently control the cutting operation.

What is claimed is:

1. A cutting speed display device installed in a band saw, said band saw comprising a frequency converter, a motor, a driving wheel set and a band saw blade, said frequency converter being adapted for regulating the speed of said motor, said motor being adapted for rotating said driving wheel set to move said band saw blade, said driving wheel set being comprised of a plurality of driving wheels, said driving wheels having different diameters and being selectively coupled to said motor for driving said band saw blade, the cutting speed display device comprising
a modulator electrically connected to said frequency converter and adapted for outputting a linear modulation signal to said frequency converter to modulate the frequency of the output electrical power of said frequency converter and to further regulate the speed of said motor, and
a display device, said display device comprising a circuit device electrically connected to the modulator and a display panel electrically connected to said circuit device, said circuit device being adapted for receiving the linear modulation signal outputted by said modulator and converting the received linear modulation signal into a band saw blade cutting speed for display on said display panel subject to one of a number of calculation modules set therein.

2. The cutting speed display device as claimed in claim 1, wherein said modulator is a variable resistor.

3. The cutting speed display device as claimed in claim 1, wherein said modulator is comprised of two variable resistors that are linked together.

4. The cutting speed display device as claimed in claim 1, wherein said display device comprises a plurality of switch buttons for switching the calculation mode of said circuit device.

5. The cutting speed display device as claimed in claim 1, further comprising a sensor installed in said driving wheel set and electrically connected to said display device to automatically switch the calculation mode of said circuit device.
